(19) United States
(12) Patent Application Publication
(10) Pub. No.: US 2012/0111760 A1
(43) Pub. Date: May 10, 2012

(54) EASY-TO-OPEN PACKAGE

(75) Inventors: Guilio Benedetti, Solbiate Arno (Varese) (IT); Jvanohe Rizzi, Legnano (Milan) (IT)

(73) Assignee: CRYOVAC, INC., Duncan, SC (US)

(21) Appl. No.: 13/384,359

(22) PCT Filed: Jul. 28, 2010
(86) PCT No.: PCT/EP2010/060962

§ 371 Date: Jan. 17, 2012

(30) Foreign Application Priority Data
Jul. 29, 2009 (EP) EP09166716.2

(51) Int. Cl. B65D 85/00; B31B 1/00

(52) U.S. Cl. 206/524.6; 493/84

(57) ABSTRACT

It is disclosed an easy-to-open package comprising: a support comprising a multi-layer substrate and a lower sealing layer, the support having a pre-cut forming an angular tab and a main body of the support; a product arranged on the support; and a covering film covering the product and having an upper sealing layer adhering to the lower sealing layer on a portion of the support comprising at least the angular tab. The easy-to-open package is characterized in that it further comprises an adhesion weakening element arranged on the main body of the support between the lower sealing layer and the upper sealing layer next to the pre-cut.

### TECHNICAL FIELD

The present invention relates to an easy-to-open package and to a machine and process for assembling an easy-to-open package.

### BACKGROUND ART

A wide variety of products, especially food products like meat, sausages, cheese and the like, are often offered in visually attractive packages made of two webs (namely, a lower web and an upper web) using a vacuum skin packaging process, a thermoforming process or other methods.

The lower web is typically used as a support for the product and may be flat or heated and thermoformed to the desired shape, thus forming a receptacle for the product to be packaged. The lower web typically comprises a rigid or semi-rigid substrate, such as for instance of a plastic or cardboard material, and a sealing layer. The upper web is typically a flexible and formable film with a sealing layer that, in the end package, faces the sealing layer of the lower web.

In a vacuum skin packaging process, after forming (if desired) and filling the lower web, the upper web is drawn over the product by vacuum, heated, and then moulded down upon and around the product and against the lower web, the space between the lower web and the upper web having been evacuated. The heated upper web thus forms a tight skin around the product and is sealed to the lower web by differential air pressure (venting from above the upper web while the space between the lower and upper webs is under vacuum).

In the thermoforming process, after forming the lower web and filling it with the product to be packaged, air is evacuated from the sealing die, if a vacuum or a modified atmosphere package is desired, and optionally replaced by a suitable gas or gas-mixture. Then the upper web is lowered over the product and sealed to the peripheral flange-like edges of the support created in the lower web typically using a heat sealing frame.

A package of the above type may be opened by cutting the upper web and/or the lower web by means e.g. of scissors or knives.

In the art, a particular type of package is known, that is called “easy-to-open package”. An easy-to-open package is a package that may be opened by manually pulling apart the upper and lower webs, typically starting from a corner of the package where the upper web has purposely not been sealed to the lower web.

In a first known type of easy-to-open package, opening of the package is achieved by means of a “peelable” seal, i.e., a seal between the upper and lower webs that can be opened in the plane of joining the upper and lower webs by the action of a pulling force, without wrenching off or tearing occurring in the material of the upper and lower webs. In a second known type of easy-to-open package, opening of the package is achieved by an initial breakage through the thickness of one of the sealing layers followed by delamination of this layer from the underlying layer in either the lower web or the upper web. In a third known type of easy-to-open package, opening of the package is achieved by internal rupture (e.g. cohesive failure) of a sealing layer that, during opening of the package, breaks along a plane parallel to the sealing layer itself. Alternatively, in this third known type, internal rupture may occur in an inner layer adjacent to the sealing layer, that is termed “easy-opening layer”; in this case, during opening of the package, internal rupture of the easy-opening layer occurs after the sealing layer breaks through its thickness.

U.S. Pat. No. 6,476,137 discloses an easy-to-open package of the third known type, having a support and a film. The support comprises at least three layers: a substrate, a sealing layer and an easy-opening layer interposed between the substrate and the sealing layer. The easy-opening layer is made of a material that undergoes internal rupture when a transversal force of 2.00 to 6.00 N/25.4 mm is applied to the easy-opening layer. A corner of the support has a pre-cut forming a tab. The film comprises at least two layers: a substrate and a sealing layer. The film covers substantially the whole support, included the tab. The easy-to-open package of U.S. Pat. No. 6,476,137 may be opened by grasping and pulling the tab (with a corresponding angle of the film attached thereto). This induces breakage of the sealing layer of the support and cohesive failure of the easy-opening layer, that breaks along a plane parallel to the sealing layer itself.

### SUMMARY OF THE INVENTION

The Applicant has noticed that the easy-to-open packages of the three known types described above, and in particular those of the first type (i.e. those having a “peelable” seal) and those of the third type (i.e. those having an “easy-opening layer”, such as that of U.S. Pat. No. 6,476,137), may have some drawbacks in case the substrate of the lower web has a multi-layer structure.

Indeed, the easy-opening layer of U.S. 6,476,137 allows properly opening of the easy-to-open package only if the adhesion force between the various layers of the substrate at the pre-cut is higher than the breaking force of the easy-opening layer. Otherwise, pulling the tab may induce delamination of the layers of the substrate, while the easy-opening layer remains intact.

This happens, for instance, when the substrate has a multi-layer structure comprising a cardboard covered by e.g. a layer of PET (polyethylene terephthalate). The adhesion force between the PET layer and the underlying cardboard at the pre-cut is comparable to the breaking force of the easy-opening layer. Therefore, when the tab is pulled, delamination of the PET layer from the cardboard is disadvantageously induced, and the easy-to-open package can not be opened in a proper way.

Delamination of the layers of the substrate may happen also in the easy-to-open packages having the above mentioned “peelable” seal, if the adhesion force between the upper and lower webs at the pre-cut is higher than the adhesion force between the various layers of the substrate of the lower web.

Accordingly, the Applicant has tackled the problem of providing an easy-to-open package wherein, in case the substrate of the lower web has a multi-layer structure, risk of delamination of the substrate is minimized, even when, if the easy-to-open package includes an easy-opening layer, the adhesion force between the various layers of the substrate at the pre-cut is comparable to the breaking force of the easy-opening layer and even when, if the easy-to-open package has a “peelable” seal, the adhesion force between the various layers of the substrate at the pre-cut is comparable to the adhesion force between the upper and lower webs.

According to a first aspect, the present invention provides an easy-to-open package comprising:
a support comprising a multi-layer substrate and a lower sealing layer, the support having a pre-cut forming an angular tab and a main body of the support;
a product arranged on the support; and
a covering film covering the product and having an upper sealing layer adhering to the lower sealing layer on a portion of the support comprising at least the angular tab,
   the easy-to-open package being characterized in that it further comprises an adhesion weakening element arranged on the main body of the support between the lower sealing layer and the upper sealing layer next to the pre-cut.

Preferably, the adhesion weakening element comprises a strip of low adhesion fluid applied on the lower sealing layer.

Preferably, the low adhesion fluid is a silicon or mineral oil with a viscosity of at least 8.5 cSt at 100° C.

Profitably, the strip has a width comprised between 1 mm and 3 mm.

Preferably, the multi-layer substrate has a first layer of cardboard and a second layer of PET. Alternatively, the multi-layer substrate has a first layer of foamed thermoplastic material and a second layer of a solid polymer other that the one used for the first layer.

Preferably, the covering film is made of a multi-layer thermoplastic material.

Preferably, the upper sealing layer comprises a polyethylene homo- co-polymer or a blend of polyethylene (co)polymers.

In one preferred embodiment, the support further comprises an easy-opening layer interposed between the multi-layer substrate and the lower sealing layer.

Preferably, the easy-opening layer is made of a blend comprising:
a copolymer of ethylene and acrylic acid or methacrylic acid;
a modified EVA copolymer, i.e. ethylene-vinyl acetate based copolymer modified either by the presence of a third unit in the polymer chain or by blending therewith or grafting thereon another modifying component; and
a polybutylene.

Profitably, the easy-opening layer undergoes internal rupture when a transversal force of from 2.00 to 6.00 N/25.4 mm is applied.

Preferably, in said embodiment the lower sealing layer has a tensile stress at break evaluated according to the standard method ASTM D882 in the range 100-250 kg/cm², and a maximum elongation at break of 500%.

Preferably, in said embodiment the lower sealing layer comprises a polyolefin selected of: ethylene homo-polymers, ethylene-copolymers with one or more co-monomers selected from α-olefins, vinyl acetate, acrylic or methacrylic acids, and acrylic or methacrylic lower alkyl esters, ionomers.

In another preferred embodiment profitably, the lower sealing layer comprises a peelable blend selected from: a blend of polybutene-1 with possibly modified LDPE or HDPE, a blend of polybutene-1 with styrenic olefinic block copolymer and a blend of polystyrene with ethylene copolymers.

According to a second aspect, the present invention provides a machine for assembling an easy-to-open package, the machine comprising:
a pre-cutting assembly suitable for cutting a pre-cut in a support having a multi-layer substrate and a lower sealing layer, the pre-cut forming an angular tab and a main body of the support;
a product arranging assembly suitable for arranging a product on the support; and
a packaging assembly suitable for applying a coverage film having an upper sealing layer on the product, so that the upper sealing layer adheres to the lower sealing layer on a portion of the support comprising at least the angular tab,
   the machine being characterized in that the pre-cutting assembly is further configured to apply an adhesion weakening element on the main body of the support between the lower sealing layer and the upper sealing layer next to the pre-cut.

Preferably, the pre-cutting assembly comprises a pre-cutting blade and a pad laying against the pre-cutting blade, the pad being preferably soaked in a low-adhesion fluid, the low-adhesion fluid preferably being a silicone or a mineral oil. Alternatively, the pre-cutting assembly comprises a pre-cutting blade and a device for applying low adhesion fluid onto the pre-cutting blade.

According to a third aspect, the present invention provides a process for assembling an easy-to-open package, the process comprising:
a) providing a support having a multi-layer substrate and a lower sealing layer;
b) cutting a pre-cut on the support so as to form an angular tab and a main body of the support;
c) arranging a product on the support; and
d) applying a coverage film having an upper sealing layer on the product so that the upper sealing layer adheres to the lower sealing layer on a portion of the support comprising at least the angular tab,
   the process being characterised in that step b) comprises applying an adhesion weakening element on the main body of the support between the lower sealing layer and the upper sealing layer next to the pre-cut.

Preferably the adhesion weakening element comprises a low-adhesion fluid.

Profitably said low-adhesion fluid is a silicone or mineral oil with a viscosity of at least 8.5 cSt at 100° C. and lower than 300 cSt at the working temperatures of the packaging process.

### BRIEF DESCRIPTION OF THE DRAWINGS

The present invention will become clearer by reading the following detailed description, given by way of example and not of limitation, to be read with reference to the accompanying drawings, wherein:

FIG. 1 is an axonometric view of an easy-to-open package;

FIGS. 2a to 2c are cross-sectional views of a portion of the easy-to-open package of FIG. 1 along the section plane P shown in FIG. 1, according to a first preferred embodiment of the present invention;

FIG. 3 schematically shows a machine suitable for assembling the easy-to-open package of FIG. 1, according to a preferred embodiment of the present invention;

FIGS. 4a to 4e schematically show various steps of the process for assembling the easy-to-open package of FIG. 1;

FIGS. 5a to 5d show in detail sub-steps of the pre-cut step of FIG. 4b; and

FIGS. 6a to 6c are cross-sectional views of a portion of the easy-to-open package of FIG. 1 along the section plane P shown in FIG. 1, according to a second preferred embodiment of the present invention.

### DETAILED DESCRIPTION OF PREFERRED EMBODIMENTS OF THE INVENTION

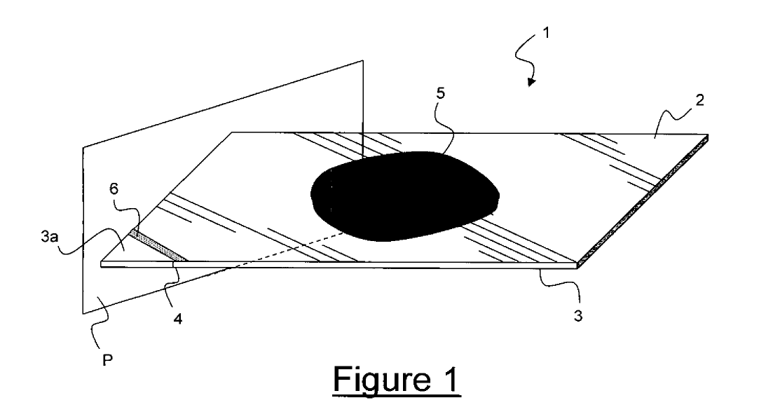

FIG. 1 shows an easy-to-open package 1.

The easy-to-open package 1 preferably comprises a support 3 and a covering film 2. A product 5 is arranged on the support 3, and the covering film 2 is arranged so as to cover the product 5 and the support 3. The covering film 2 is preferably applied to the product 5 and the support 3 by means of e.g. a vacuum skin procedure or a perimetral seal with or without vacuum or a modified atmosphere inside the package.

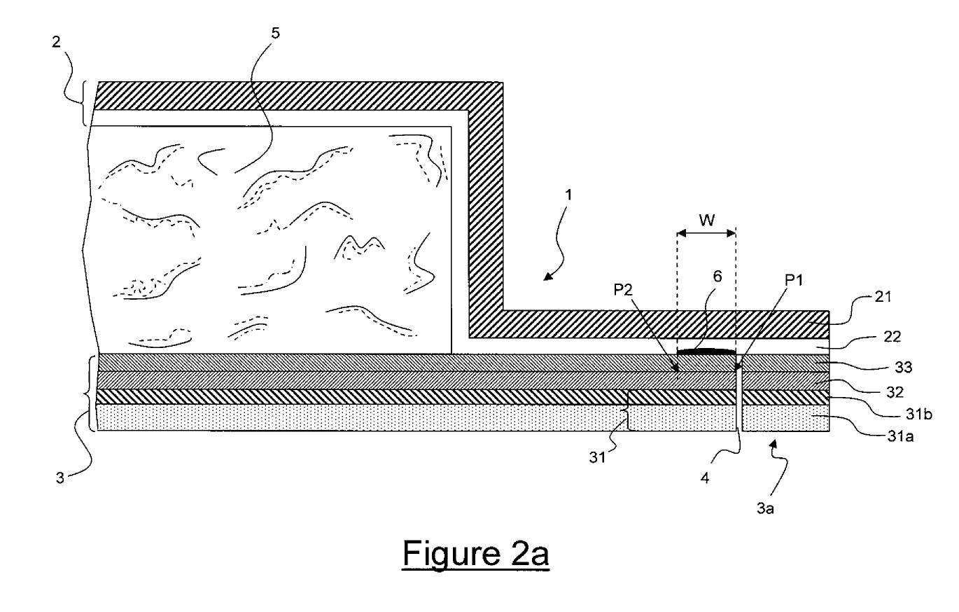

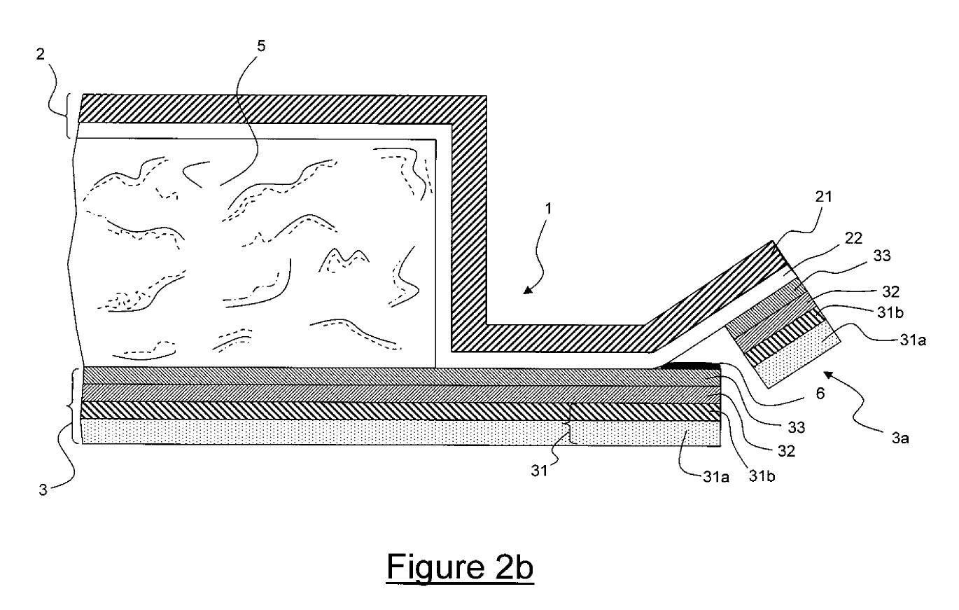

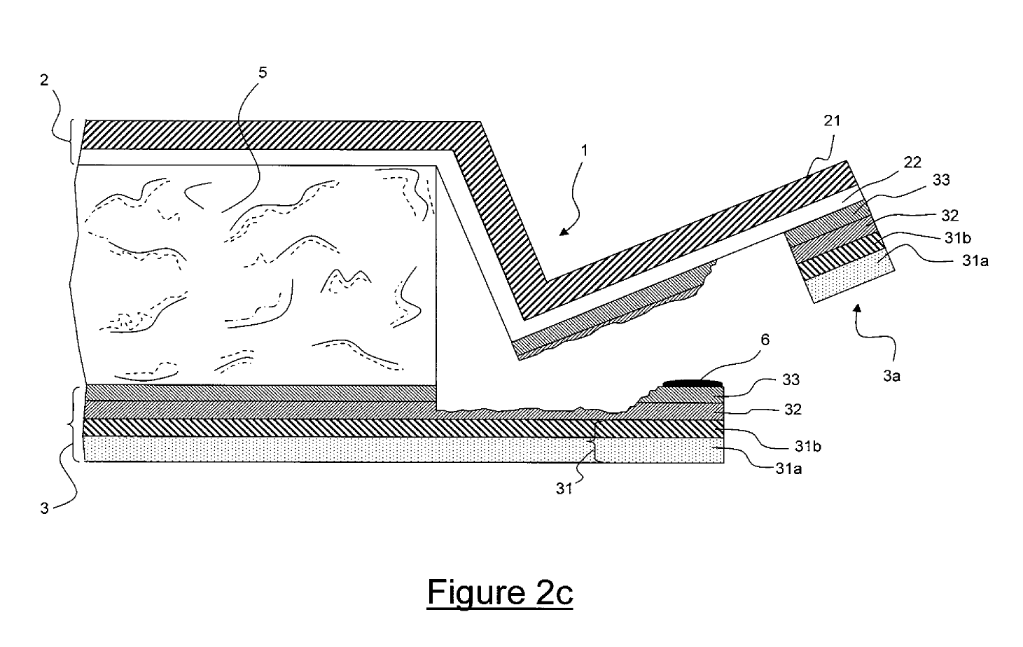

With reference to FIG. 2a, according to a first preferred embodiment the support 3 preferably comprises a lower substrate 31, an easy-opening layer 32 laying on the lower substrate 31 and a lower sealing layer 33 laying on the easy-opening layer 32.

The lower substrate 31 preferably has a multi-layered structure comprising at least two layers 31a and 31b. For instance, the lower substrate 31 may comprise a first layer 31a of cardboard and a second layer 31b of PET applied on the cardboard. Alternatively, the first layer 31a may be of a foamed thermoplastic material and the second layer 31b may be of a solid polymer other that the one used for the foamed layer. For instance, the first layer 31a may be of a cardboard of 200, 300, 400 microns or up to 750 microns coated with a PET layer that may suitably be from 10 to 60 micron thick. Alternatively, the first layer 31a may be of polystyrene foam up to 700-800 micron thick and second layer 31b may be a solid optionally modified polyolefin or PET layer of from 10 to 60 microns. The lower substrate 31 may comprise additional layers, besides those indicated as 31a and 31b. In particular there might be additional layers positioned between the first layer 31a and the second layer 31b, and/or on the sides of said layers 31a and 31b that do not face each other. As an example, an outer abuse resistant layer, such as for instance a layer of polyethylene homo- or co-polymers in case of a first layer 31a of cardboard or a layer of a solid polystyrene such as HIPS in case of a first layer 31a of foamed polystyrene (to improve the mechanical properties of the support 3), may be present on the side of the first layer 31a not facing the second layer 31b. In such a case, an adhesive or a glue layer may also be present between said abuse resistant layer and the first layer 31a.

The easy-opening layer 32 preferably comprises a blend of poorly compatible polymers that will fail, when a suitable transversal force is applied thereto, leading to a breakage along a plane parallel to the easy-opening layer 32 itself. Examples of suitable blends are for instance
i) a blend comprising, as described in EP-B-192,131:
   an ionomer having a melt flow index of less than 5 and
   a modified ethylene-vinyl acetate copolymer having a substantially higher melt flow index, whereby the melt flow indices of the two polymers in the layer differ by at least 10,
ii) a blend comprising, as described in WO 2003/20608:
   an EVA copolymer containing from more than 40 to 80 wt. % vinyl acetate,
   a polybutene, and
   an optionally neutralized ethylene-acrylic or methacrylic acid copolymer; or
iii) a blend comprising, as described in U.S. Pat. No. 6,476,137:
   a copolymer of ethylene and acrylic acid or methacrylic acid (preferably containing from about 4% to about 18% by weight of acrylic or methacrylic acid units);
   a modified EVA copolymer (i.e. ethylene-vinyl acetate based copolymer that may be modified either by the presence of a third unit, such as CO, in the polymer chain or by blending therewith or grafting thereon another modifying component); and
   a polybutylene.

In a most preferred embodiment, this last blend iii) is employed which preferably comprises from about 35 wt. % to about 83 wt. % of the copolymer of ethylene and acrylic acid or methacrylic acid, from about 15 wt. % to about 30 wt. % of the modified EVA copolymer and from about 2 wt. % to about 50 wt. % of the polybutylene.

The easy-opening layer 32 made of such a blend preferably undergoes internal rupture when a transversal force of from 2.00 to 6.00 N/25.4 mm is applied.

The blend used for the easy-opening layer 32 is obtained by mixing the various components and then melt extruding the obtained mixture.

The easy-opening layer 32 preferably has a thickness comprised between 2 microns and 30 microns, e.g. comprised between 3 or 4 or 5 or 6 or 7 or 8 or 9 or 10 microns and 20 or 21 or 22 or 23 or 24 or 25 or 26 or 27 or 28 or 29 microns.

The easy-opening layer 32 is preferably coextruded with the lower sealing layer 33 and possibly with other layers, not indicated in the drawings, positioned on the side of the easy-opening layer 32 other than the side where the lower sealing layer 33 is present, and the obtained structure is then applied onto the lower substrate 31, preferably by means of a glue lamination process.

Said other possible layers may comprise for instance oxygen barrier layers, bulk layers, and tie layers as known in the art.

The lower sealing layer 33 preferably comprises a polyolefin and has a thickness comprised between 1 micron and 10 microns, typically comprised between 1.5 and 8 microns, and preferably in the range from 2 to 5 microns. Preferred materials for the lower sealing layer 33 are for example those characterized by a tensile stress at break (evaluated according to the standard method ASTM D882) in the range 100-250 kg/cm². Preferably said materials are also characterized by a maximum elongation at break of 500%.

In the package 1, the support 3 usually has a rectangular shape, possibly with rounded corners, and is provided with a pre-cut 4 at one of the angles thereof, forming an angular tab 3a. Alternative shapes are however possible and for certain products also preferred, such as triangular shapes for e.g. cheese chunks, with the angular tab 3a in the sharp corner. Alternatively, the support 3 may have squared shape with the angular tab 3a in any of the corners. The pre-cut 4 preferably extends through the whole thickness of the support 3 so that the angular tab 3a is physically detached from the rest of the support 3 (that will be termed herein after “main body of the support 3”). The support 3 preferably has an overall thickness lower than 1200 microns.

The covering film 2 is typically made of a multi-layer thermoplastic material which comprises an upper sealing layer 22 and one or more other layers, indicated in the drawings as the upper substrate 21. The upper sealing layer 22 is suitably selected to heat-seal to the lower sealing layer 33. When, according to a preferred embodiment, the lower sealing layer 33 of the support 3 comprises a polyolefin, also the upper sealing layer 22 of the covering film 2 comprises a polyolefin that would heat-seal to the lower sealing layer 33. The composition of the lower sealing layer 33 and upper sealing layer 22 can be equal or different. Examples of suitable polyolefins that can be used alone or in blends for the lower sealing layer 33 and upper sealing layer 22 are e.g., ethylene homo-polymers, ethylene-copolymers with one or more co-monomers selected from α-olefins, vinyl acetate, acrylic or methacrylic acids, and acrylic or methacrylic lower alkyl esters, ionomers, and the like polymers. The thickness of the upper sealing layer 22 is not critical and may be comprised between 4 micron and 30 microns. The upper substrate 21 may comprise more than one layer, including an outer abuse-resistant layer, and/or a gas-barrier layer, and/or one or more bulk layers and/or one or more tie layers to improve the bond between the various layers of the structure. If a vacuum skin packaging process is applied, the polymers used for the manufacture of the covering film 2 will be suitably chosen to provide the structure with the desired formability as known in the art. In such a case, typical polymers for the bulk layers will be polyolefins such as ethylene homo- or co-polymers and ionomers. The overall thickness of the covering film 2 is typically comprised between 40 and 200 microns, preferably comprised between 50 microns and 150 microns. As mentioned above, in the vacuum skin packaging process the covering film 2 is arranged so as to form a tight skin around the product 5 and on the support 3. In particular, in the areas of the support 3 that are not engaged by the product 5 (included the angular tab 3a), the covering film 2 and the support 3 are sealed by adhesion of the upper sealing layer 22 to the lower sealing layer 33.

According to the present invention, the easy-to-open package 1 further comprises an adhesion weakening element 6 interposed between the lower sealing layer 33 and the upper sealing layer 22, placed on the main body of the support 3 next to the pre-cut 4. Preferably, the adhesion weakening element 6 is a strip of a low-adhesion fluid lying on the lower sealing layer 33. The low-adhesion fluid is preferably an oil approved for food applications, that may be easily pumped, but that is sufficiently viscous at the temperatures of use in the packaging process to allow an easy and precise application in the small quantity required by the process on the layer 33, avoiding oil stain inside or outside the package that might impair the appearance of the package and compromise the sealing. Oils with a viscosity of at least 8.5 cSt at 100° C. and lower than 300 cSt, preferably lower than 250 cSt, at the working temperatures may suitably be employed in the manufacturing process of the present invention as low-adhesion fluids. Working temperatures depend on the product to be packaged. For instance, in case of fresh meat, the working temperature is between 0° C. and 4° C., while in case of less sensitive products the working temperature may be easily up to 20-25° C. Suitable oils are preferably non-volatile oils. However, it is also possible to use volatile oils, provided the volatile component does not create safety problems in the packaging process and the residue which is left on the sealing layer 33 is a low-adhesion residue that does not heat-seal to the sealing layer of the covering film 22. Preferred oils are silicone oils and mineral oils of medium or high viscosity. Suitable commercial oils can be found for instance among the polydimethylsiloxanes distributed as Dow Corning® 200 fluids or the Purity White Mineral Oils provided by Petro-Canada Europe Lubricants. The adhesion weakening element 6 preferably extends on the lower sealing layer 33 substantially along the whole length of the pre-cut 4, and has a width W preferably comprised between 1 mm and 3 mm, more preferably equal to 2 mm.

When a consumer wishes to open the easy-to-open package 1 for accessing the product 5, she/he may advantageously grasp the angular tab 3a with an angle of the covering film 2 attached thereto, and pull it so as to move the covering film 2 away from the support 3.

Firstly, as shown in FIG. 2b, pulling the angular tab 3a causes the upper sealing layer 22 to move away from the lower sealing layer 33 in the area corresponding to the adhesion weakening element 6. Successively, as shown in FIG. 2c, further pulling the angular tab 3a causes breakage of the lower sealing layer 33 through its thickness and internal rupture of the easy-opening layer 32 The easy-opening layer 32 preferably breaks until the product 5. The weight of the product 5 advantageously prevents the easy-opening layer 32 from breaking also underneath the product 5 itself. This advantageously prevents removing the lower sealing layer 33 from the underlying substrate 31 with the product 5 encapsulated between the lower sealing layer 33 and the covering film 2.

Therefore, advantageously, no delamination of the lower substrate 31 occurs, even if the lower substrate 31 has a multi-layer structure with layers whose adhesion force at the pre-cut 4 is comparable to the breaking force of the easy-opening layer 32. Indeed, the adhesion weakening element 6 creates an area of low adhesion between the upper sealing layer 22 and the lower sealing layer 33 next to the pre-cut 4. This area of low adhesion advantageously moves the line along which traction force is applied to the easy-opening layer 32 and the lower support 31 from a first position P1 (shown in FIG. 2a) arranged next to the pre-cut 4 to a second position P2 (also shown in FIG. 2a) arranged substantially at a distance W from the pre-cut 4. The adhesion force between the layers of the lower substrate 31 is advantageously higher along the line positioned at the second position P2 than along the line positioned at the first position P1. In particular, the adhesion force between the layers of the lower substrate 31 along the line positioned at the second position P2 is advantageously higher than the breaking force of the easy-opening layer 32. Increase of the adhesion force is advantageously due to the fact that, while at the first position P1 the layers of the lower substrate 31 adhere at a single side of the line along which the traction force is applied (since the other side is engaged by the pre-cut 4), at the second position P2 the layers of the lower substrate 31 adhere at both sides of the line along which the traction force is applied. Therefore, after the upper sealing layer 22 and the lower sealing layer 33 are separated in the area corresponding to the adhesion weakening element 6, the upper sealing layer 22 transmits the traction force applied by pulling the angular tab 3a to the layers below, i.e. the lower sealing layer 33, the easy-opening layer 32 and the lower substrate 31 along the line positioned at second position P2.

This traction force firstly induces breakage of the lower sealing layer 33 through its thickness, since the breaking force of the sealing layer 33, as disclosed above, is preferably very low. Then, the traction force is applied directly to the easy-opening layer 32 and the lower substrate 31. However, since the adhesion force of the layers of the lower substrate 31 is now higher than the breaking force of the easy-opening layer 32, the easy-opening layer 32 undergoes internal rupture, while the lower substrate 31 remains intact (i.e. its layers do not delaminate). Therefore, advantageously, the easy-to-open package 1 is properly opened.

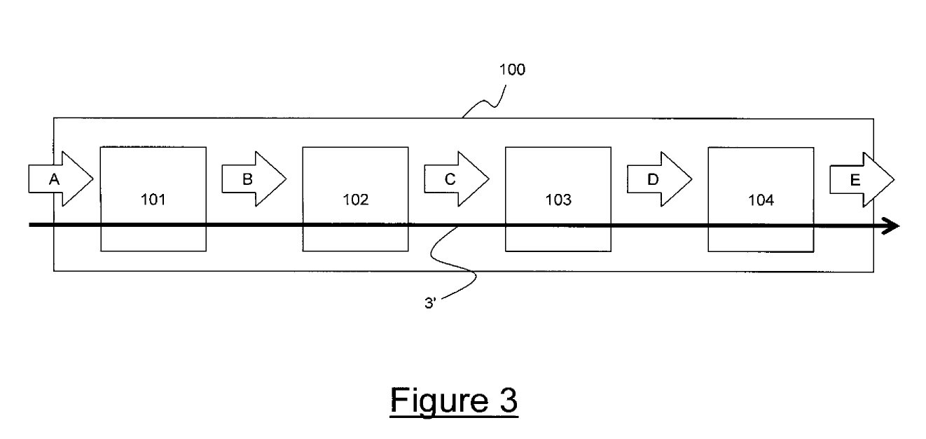

FIG. 3 schematically shows a machine 100 for assembling the easy-to-open package 1, according to a preferred embodiment of the present invention.

The machine 100 preferably comprises a pre-cutting assembly 101, a product arranging assembly 102, a packaging assembly 103 and a cutting assembly 104. The machine 100 further comprises two lateral gripper chains, or other equivalent devices (gripper belts, chains with pin, pinch rollers) driving a lower web 3′ through the above assemblies and a stepping motor unit connected to the chains or other devices (not shown in FIG. 3) suitable for operating step-by-step the lower web 3′. The arrows A, B, C, D and E of FIG. 3 symbolically indicate the input and the output of each assembly. The Applicant has performed some positive tests using a known Multivac® Darfresh® R570 machine where the pre-cutting assembly 101 has been modified as it will be described in detail herein after.

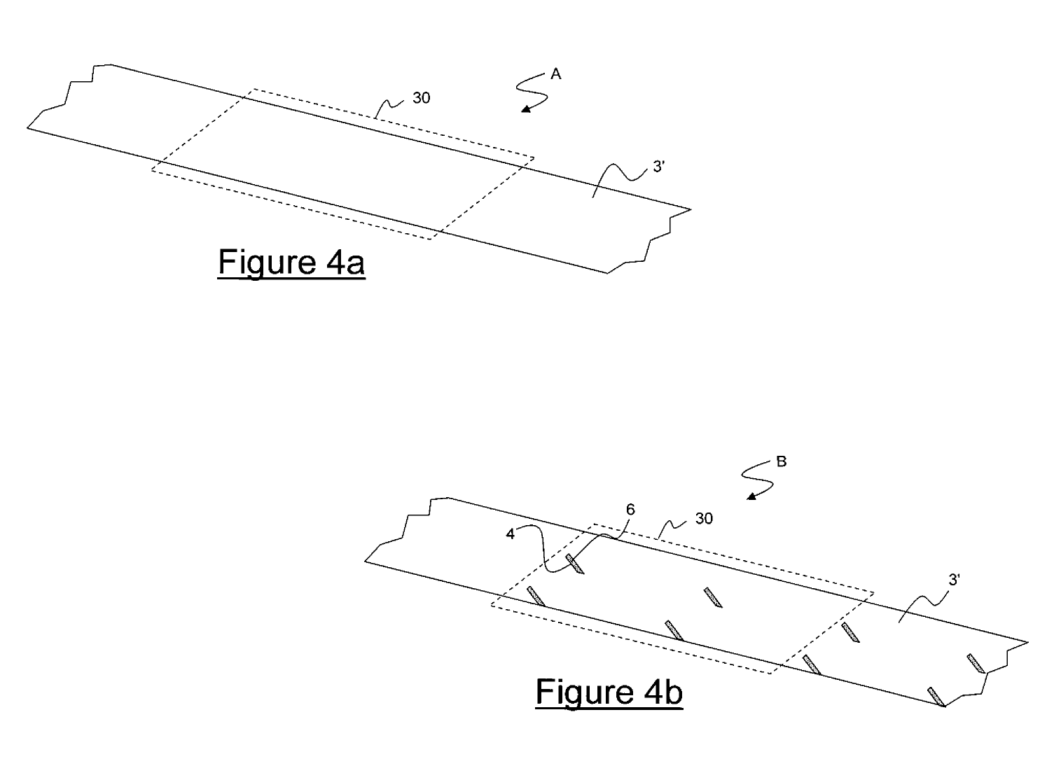

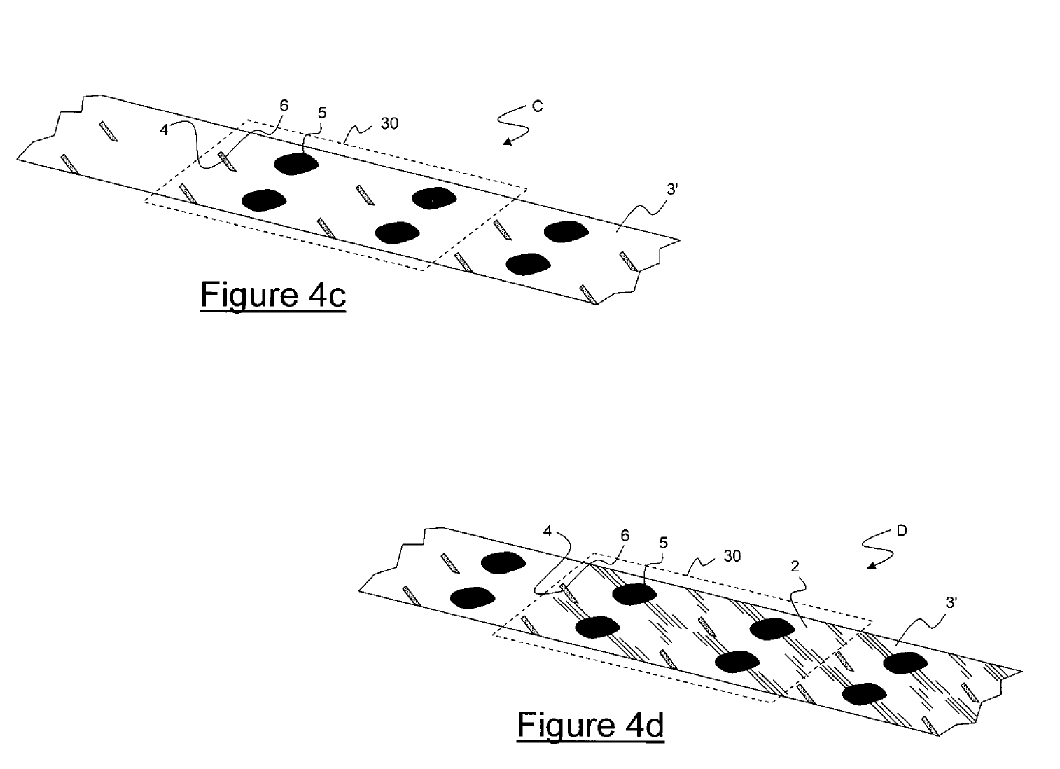

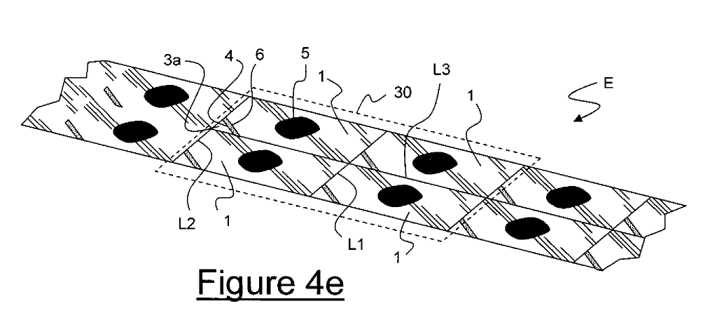

With reference also to FIGS. 4a to 4e, the operation of the machine 100 will be described in detail.

First of all a lower web 3′ is provided, having the multi-layered structure of the support 3 of the package shown in FIGS. 2a to 2c (i.e. it comprises a lower substrate layer 31, an easy-opening layer 32 and a lower sealing layer 33). The lower web 3′ is laterally pinched by suitable clips of two gripper chains and thus conveyed step-by-step through the pre-cutting assembly 101, the product arranging assembly 102, the packaging assembly 103 and the cutting assembly 104.

If a tray-shaped support 3 is desired instead of a flat one, an upstream forming assembly (not shown in the drawings) may be foreseen.

In the first step of the process, a portion 30 of the lower web 3′ (shown in FIG. 4a) enters the pre-cutting assembly 101.

The pre-cutting assembly 101 preferably cuts a number of pre-cuts 4 in the portion 30 of the lower web 3′ and applies an adhesion weakening element 6 on the portion 30 next to each pre-cut 4 (FIG. 4b). By way of example, FIG. 4b shows that four pre-cuts 4 are cut in the portion 30.

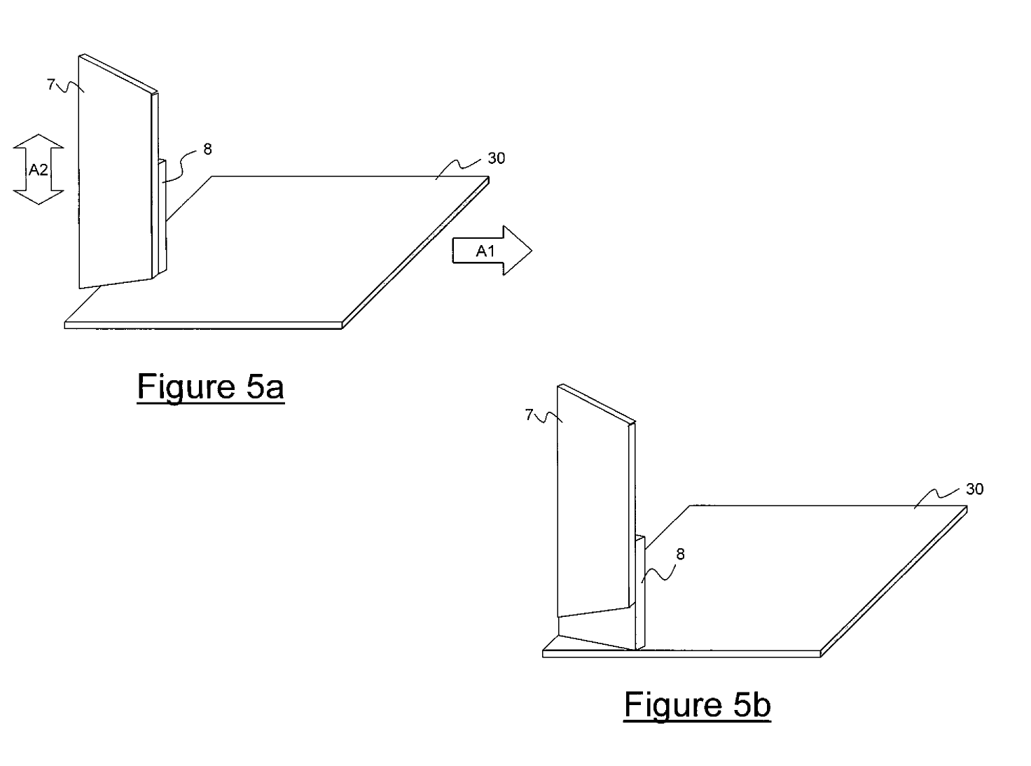

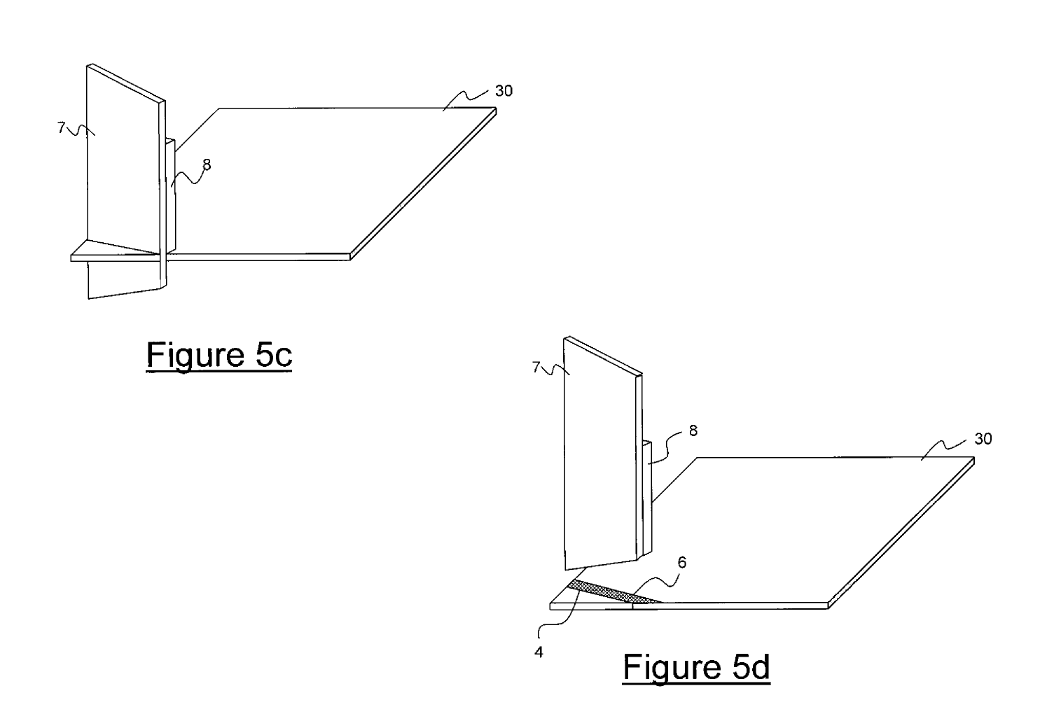

FIGS. 5a to 5d show the operation of the pre-cutting assembly 101 in further detail. As shown in FIG. 5a, the pre-cutting assembly 101 preferably comprises a pre-cutting blade 7 and a pad 8 laying against the pre-cutting blade 7. The pad 8 is preferably soaked in a low-adhesion fluid, the low-adhesion fluid preferably being a silicone or a mineral oil. The pad 8 preferably has substantially the same length as the pre-cutting blade 7, and has a width of about 2 mm. Both the pre-cutting blade 7 and the pad 8 are arranged obliquely relative to the longitudinal direction of the lower web 3′ (indicated by the arrow A1 in FIG. 5a). Both the pre-cutting blade 7 and the pad 8 are suitable for sliding along the vertical direction indicated by the double arrow A2 of FIG. 5a. With reference to FIG. 5b, and according to a preferred embodiment, when the portion 30 of the lower web 3′ enters the pre-cutting assembly 101, the pad 8 is lowered along the vertical direction indicated by the double arrow A2 of FIG. 5a, until it enters into contact with the upper surface of portion 30 of the lower web 3′, thereby applying an adhesion weakening element 6 (i.e. a strip of low-adhesion fluid, specifically a silicone or a mineral oil) on the portion 30 of the lower web 3′. Then, while the pad 8 is in contact with the upper surface of the portion 30 of the lower web 3′, also the pre-cutting blade 7 is lowered along the vertical direction indicated by the double arrow A2 of FIG. 5a, thereby cutting a pre-cut 4 adjacent to the adhesion weakening element 6 (FIG. 4c) in the portion 30 of the lower web 3′. The pre-cutting blade 7 and the pad 8 are finally raised along the vertical direction indicated by the double arrow A2 of FIG. 5a (FIG. 5d).

Even if FIGS. 5a to 5d show a single pre-cutting blade 7 with a single pad 8, the pre-cutting assembly 101 preferably comprises a number (e.g. four) of pre-cutting blades 7 and a respective number of pads 8 operated substantially simultaneously, so as to cut a number of pre-cuts 4 and apply a respective number of adhesion weakening elements 6 in a single step.

Alternatively, the order of the steps of creating the pre-cut 4 and applying the adhesion weakening element 6 may be inverted, i.e. the pre-cutting blade 7 may be lowered to create the pre-cut 4 before the lowering of the soaked pad 8 to apply the strip of the low-adhesion fluid. Alternatively, the two steps may be carried out simultaneously by lowering the pre-cutting blade 7 and the soaked pad 8 substantially at the same time.

According to another alternative embodiment not shown in the drawings, instead of providing the pad 8 soaked in a low-adhesion fluid, the pre-cutting assembly 101 may comprise a device suitable for applying the low-adhesion fluid directly on the pre-cutting blade 7 before the pre-cut. In that case, the operations of applying the adhesion weakening element 6 and cutting the pre-cut 4 are performed as a single operation, by simply lowering the pre-cutting blade 7 as shown in FIG. 5c.

Further alternatively, it is also possible to apply the strip of the low adhesion fluid, still next to the pre-cut 4, by means of a dropper, nozzle or other dosing device able to spread the oil on the lower web 3′ or on the pre-cutting blade 7 with or without contacting it.

After the pre-cuts 4 have been cut in the portion 30 of the lower web 3′ and the adhesion weakening elements 6 have been applied next to each pre-cut 4, the portion 30 of the lower web 3′ is brought by the side chains to the product arranging assembly 102.

The product arranging assembly 102 preferably arranges on the portion 30 of the lower web 3′ a number of products 5 to be packaged (FIG. 4c). Specifically, for each pre-cut 4 with the respective adhesion weakening element 6, a respective product 5 is arranged on the lower web 3′.

After the products 5 have been arranged on the portion 30 of the lower web 3′, during a successive step of the process, the portion 30 of the lower web 3′ enters the packaging assembly 103.

The packaging assembly 103 preferably applies the above described covering film 2 over the products 5 and the portion 30 of the lower web 3′ (FIG. 4d). This step may be performed e.g. according to the above mentioned vacuum skin packaging or thermoforming processes. When, according to a preferred embodiment, a vacuum skin packaging process is applied, the covering film 2 will drape down onto the products 5 and will adhere to the available portions of the lower web 3′.

After the covering film 2 has been applied, during a successive step of the process, the portion 30 of the lower web 3′ is moved to the cutting assembly 104.

The cutting assembly 104 preferably cuts the portion 30 of the lower web 3′ with the products 5 and the covering film 2 applied thereon into a number (corresponding to the number of products 5 arranged on the portion 30) of easy-to-open packages similar to the easy-to-open package 1 of FIG. 1, each having a support 3, a product 5 arranged thereon and the covering film 2 adhering to the product 5 and to the support 3 (FIG. 4e). Specifically, the cutting assembly 104 cuts the portion 30 along the lines L1, L2 and L3 shown in FIG. 4e. Cuts along these lines, in combination with the pre-cuts 4 provided by the pre-cutting assembly 101, form an angular tab 3a for each support 3.

Any suitable cutting device or system can be used in the cutting assembly 104. For rectangular packages a transversal cutting knife combined with one or more rotating blades to perform the longitudinal cuts is the most conventional system. Alternatively a punching system based on a male-female concept or a die cut system may serve the same scope. More flexible systems that can be considered are the use of projecting blades performing a predetermined path, the use of so-called “strip punch” systems and preferably the use of laser to easily cut the packages to any desired shape.

The above machine and process has a number of advantages.

First of all, application of the adhesion weakening element 6 to the lower web 3′ during the pre-cutting step is implemented by simply providing the pads 8 soaked into the silicone oil in the pre-cutting assembly 101, or by applying the silicone oil directly on the pre-cutting blades 7. This advantageously requires a very simple modification of the pre-cutting assembly of a Darfresh® machine, and does not require modifying the other assemblies of the machine.

Further, as the pads 8 slide against the pre-cutting blades 7 for applying the adhesion weakening element 6, they advantageously lubricate the pre-cutting blades 7, thereby improving quality of the pre-cuts 4 and increasing lifetime of the pre-cutting blades 7. This result is advantageously achieved also by applying the silicone oil directly on the pre-cutting blades 7.

Further, advantageously, the angular tabs 3a are formed by the cutting assembly 104, that cuts the lower web 3′ into a number of supports 3. At this stage, the covering film 2 has already been applied and adheres to all the upper surface of the portion 30 of the support web 3′, including the areas corresponding to the angular tabs 3a. Therefore, when the angular tabs 3a are formed, they advantageously can not detach from the main body of the respective supports 3, since they are already connected to the main body of the respective supports 3 by means of the covering film 2.

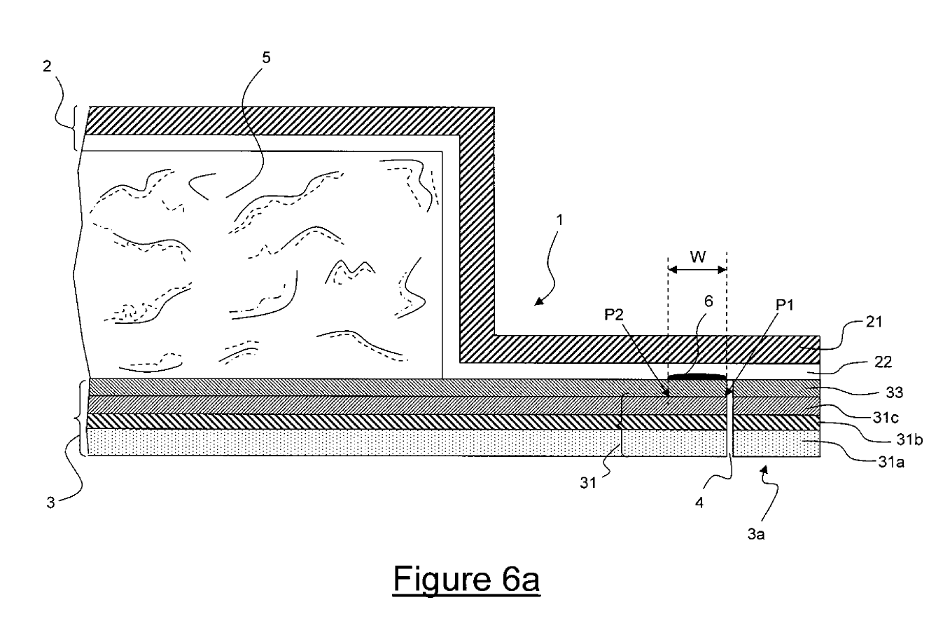

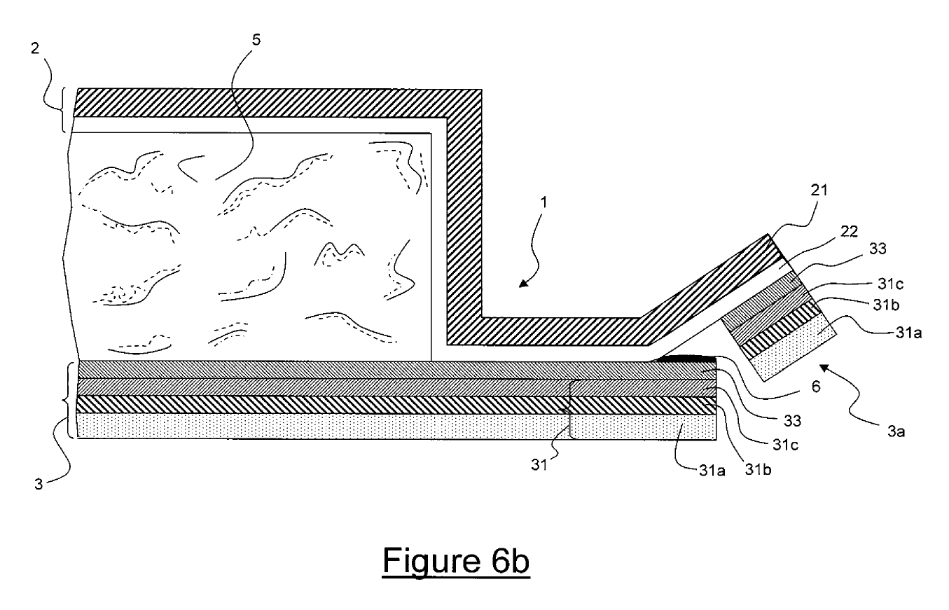

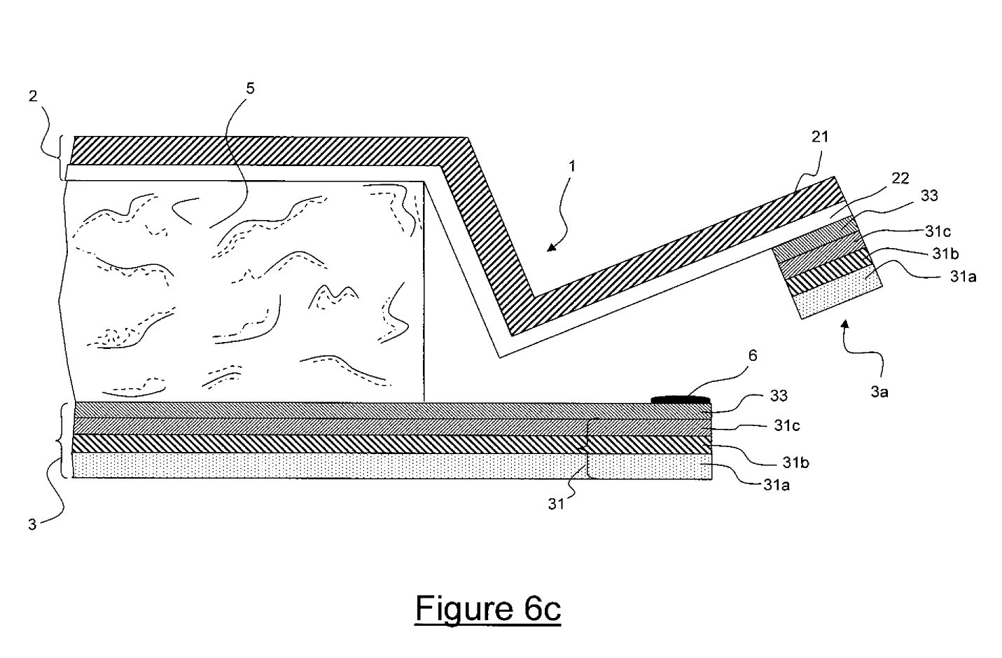

FIGS. 6a to 6c illustrate a easy-to-open package 1 according to a second preferred embodiment of the present invention. As in the first embodiment, the easy-to-open package 1 comprises a support 3 with a product 5 loaded thereon, and a covering film 2.

In the package 1 of FIGS. 6a to 6c, the covering film 2 preferably comprises an upper substrate 21 and an upper sealing layer 22. On the other hand, the support 3 has a lower substrate 31 with a multi-layered structure (i.e. it includes a first layer 31a and a second layer 31b) and a lower sealing layer 33. The upper substrate 21 and the first and second layers 31a, 31b of the lower substrate 31 are preferably as indicated for the package according to the first embodiment described with reference to FIGS. 2a to 2c. The lower substrate 31 further comprises one or more additional layers 31c, possibly including tie layers and/or bulk layers and/or gas-barrier layers, suitably selected to confer to the support 3 the properties desired.

In this second preferred embodiment, the upper sealing layer 22 and the lower sealing layer 33 are suitably designed to provide for a “peelable” seal, i.e. the seal between the covering film 2 and the support 3 can be opened in the plane of joining the covering film 2 and the support 3 by the action of a pulling force, without wrenching off or tearing occurring in the material of the covering film 2 and support 3. In particular, for example, the upper sealing layer 22 can be a polyolefin layer, e.g., a layer comprising a polyethylene homo- co-polymer or a blend of polyethylene (co)polymers, and lower sealing layer 33 may contain any of the peelable blends known in the art, e.g., the blends of polybutene-1 with possibly modified LDPE or HDPE described in EP-339,989 and EP-339,990, the blends of polybutene-1 with styrenic olefinic block copolymers described in EP-444,900, the blends of polystyrene with ethylene copolymers described in EP-797,623, and the like. Some grades of the products sold by DuPont as Appeel® can be used for the lower sealing layer 33 of the package of FIGS. 6a to 6c.

Also according to this second preferred embodiment, the support 3 has a pre-cut 4 defining an angular tab 4a and a main body of the support 3. Also according to this second embodiment, the easy-to-open package 1 comprises an adhesion weakening element 6 interposed between the lower sealing layer 33 and the upper sealing layer 22, placed on the main body of the support 3 next to the pre-cut 4. Preferably, the adhesion weakening element 6 is a strip of a low-adhesion fluid lying on the lower sealing layer 33. Preferred low-adhesion fluids have been disclosed in detail above, with reference to the first preferred embodiment. A detailed description will therefore not be repeated. When a consumer wishes to open the easy-to-open package 1 according to the second preferred embodiment for accessing the product 5, she/he may advantageously grasp the angular tab 3a with an angle of the covering film 2 attached thereto, and pull it so as to move the covering film 2 away from the support 3.

Firstly, as shown in FIG. 6b, pulling the angular tab 3a causes the upper sealing layer 22 to move away from the lower sealing layer 33 in the area corresponding to the adhesion weakening element 6. Successively, as shown in FIG. 6c, further pulling the angular tab 3a causes the upper sealing layer 22 to continue moving away from the lower sealing layer 33, until the product 5 is reached.

Therefore, advantageously, also according to this second embodiment no delamination of the lower substrate 31 occurs, even if the lower substrate 31 has a multi-layer structure with layers whose adhesion force at the pre-cut 4 is comparable to the adhesion force between the support 3 and the covering film 2 (i.e. the lower sealing layer 33 and the upper sealing layer 22). Indeed, as already discloses for the first embodiment of FIGS. 2a to 2c, the adhesion weakening element 6 creates an area of low adhesion between the upper sealing layer 22 and the lower sealing layer 33 next to the pre-cut 4. This area of low adhesion advantageously moves the line along which traction force is applied to the lower support 31 from a first position P1 (shown in FIG. 6a) arranged next to the pre-cut 4 to a second position P2 (also shown in FIG. 6a) arranged substantially at a distance W from the pre-cut 4. The adhesion force between the layers of the lower substrate 31 is advantageously higher along the line positioned at the second position P2 than along the line positioned at the first position P1. In particular, the adhesion force between the layers of the lower substrate 31 along the line positioned at the second position P2 is advantageously higher than the adhesion force between the upper sealing layer 22 and the lower sealing layer 33. As already disclosed in detail above with reference to the first preferred embodiment, increase of the adhesion force is advantageously due to the fact that, while at the first position P1 the layers of the lower substrate 31 adhere at a single side of the line along which the traction force is applied (since the other side is engaged by the pre-cut 4), at the second position P2 the layers of the lower substrate 31 adhere at both sides of the line along which the traction force is applied. Therefore, after the upper sealing layer 22 and the lower sealing layer 33 are separated in the area corresponding to the adhesion weakening element 6, the upper sealing layer 22 transmits the traction force applied by pulling the angular tab 3a to the layers below, i.e. the lower sealing layer 33 and the lower substrate 31, along the line positioned at second position P2. However, since the adhesion force of the layers of the lower substrate 31 is now higher than the adhesion force between the upper sealing layer 22 and the lower sealing layer 33, the upper sealing layer 22 is moved away from the lower sealing layer 33, while the lower substrate 31 remains intact (i.e. its layers do not delaminate). Therefore, advantageously, the easy-to-open package 1 is properly opened.

Also the easy-to-open package 1 according to this second preferred embodiment may be fabricated by using the machine shown in FIGS. 3 and performing the various steps shown in FIGS. 4a to 4e and 5a to 5d.

1.-18. (canceled)

19. An easy-to-open package comprising:
a support comprising a multi-layer substrate and a lower sealing layer, the support comprising an angular tab portion and a main body separated by a pre-cut;
a product arranged on the support;
a covering film covering the product and comprising an upper sealing layer adhering at least to the lower sealing layer of the angular tab portion; and
an adhesion weakening element arranged next to the pre-cut on the main body of the support between the lower sealing layer and the upper sealing layer.

20. The easy-to-open package according to claim 1 wherein the adhesion weakening element comprises low adhesion fluid.

21. The easy-to-open package according to claim 2 wherein the low adhesion fluid comprises a silicon or mineral oil with a viscosity of at least 8.5 cSt at 100° C.

22. The easy-to-open package according to claim 2 wherein the low adhesion fluid is configured as a strip having a width between 1 mm and 3 mm.

23. The easy-to-open package according claim 1 wherein the multi-layer substrate comprises a first layer comprising cardboard and a second layer comprising polyethylene terephthalate.

24. The easy-to-open package according to claim 1 wherein the multi-layer substrate comprises a first layer comprising foamed thermoplastic material comprising a first polymer and a second layer comprising a second polymer other than the first polymer.

25. The easy-to-open package according to claim 1 wherein the covering film comprises a multi-layer thermoplastic material.

26. The easy-to-open package according to claim 1 wherein the upper sealing layer comprises a polyethylene homo- co-polymer or a blend of polyethylene (co)polymers.

27. The easy-to-open package according to claim 1 wherein the support further comprises an easy-opening layer interposed between the multi-layer substrate and the lower sealing layer.

28. The easy-to-open package according to claim 27 wherein the easy-opening layer comprises a blend comprising:
a copolymer of ethylene and acrylic acid or methacrylic acid;
a modified ethylene/vinyl acetate copolymer; and
a polybutylene.

29. The easy-to-open package according to claim 27 wherein the easy-opening layer is adapted to internally rupture upon application of a transversal force of from 2.00 to 6.00 N/25.4 mm.

30. The easy-to-open package according to claim 9 wherein the lower sealing layer has a tensile stress at break evaluated according to the standard method ASTM D882 in the range of from 100 to 250 kg/cm2.

31. The easy-to-open package according to claim 9 wherein the lower sealing layer comprises a polyolefin selected from: (i) ethylene homo-polymers, (ii) ethylene-copolymers with one or more co-monomers selected from α-olefins, vinyl acetate, acrylic or methacrylic acids, and acrylic or methacrylic lower alkyl esters, and (iii) ionomers.

32. The easy-to-open package according to claim 1 wherein the lower sealing layer comprises a peelable blend selected from: (i) a blend of polybutene-1 with LDPE or HDPE, (ii) a blend of polybutene-1 with styrenic olefinic block copolymer, and (iii) a blend of polystyrene with ethylene copolymers.

33. A machine for assembling an easy-to-open package comprising (i) a support having a multi-layer substrate and a lower sealing layer and (ii) a coverage film having an upper sealing layer, the machine comprising:
a pre-cutting assembly suitable for cutting a pre-cut to separate the support into an angular tab portion and a main body;
a product arranging assembly suitable for arranging a product on the support; and
a packaging assembly suitable for applying the coverage film on the product so that the upper sealing layer adheres at least to the lower sealing layer of the angular tab portion;
wherein the pre-cutting assembly is configured to apply an adhesion weakening element next to the pre-cut on the main body of the support between the lower sealing layer and the upper sealing layer.

34. The machine according to claim 33 wherein the pre-cutting assembly comprises a pre-cutting blade and a pad laying against the pre-cutting blade, the pad being adapted to contain a low-adhesion fluid.

35. The machine according to claim 33 wherein the pre-cutting assembly comprises a pre-cutting blade and a device for applying low adhesion fluid onto the pre-cutting blade.

36. A process for making an easy-to-open package, the process comprising:
providing a support comprising a multi-layer substrate and a lower sealing layer;
cutting a pre-cut on the support to demarcate an angular tab portion and a main body of the support;
applying an adhesion weakening element on the main body of the support next to the pre-cut;
arranging a product on the support; and
applying a coverage film comprising an upper sealing layer on the product to adhere the upper sealing layer at least to the lower sealing layer of the angular tab portion and to enclose the adhesion weakening element between the lower sealing layer and the upper sealing layer.
